(19) United States
(12) Patent Application Publication
(10) Pub. No.: US 2010/0126066 A1
(43) Pub. Date: May 27, 2010

(54) Modular Green Roof System

(76) Inventor: David DeVos, Prairie View, IL (US)

Correspondence Address: Richards Patent Law, 3501 N. Southport Ave., Suite 493, Chicago, IL, 60657, US

(21) Appl. No.: 12/623,361

(22) Filed: Nov. 20, 2009

Related U.S. Application Data
(60) Provisional application No. 61/116,872, filed on Nov. 21, 2008.

(51) Int. Cl. A01G 9/02; A01G 1/00; E04B 7/00

(52) U.S. Cl. 47/65.9

(57) ABSTRACT

A modular green roof system includes: a bottom layer including a porous structure such that water may pass through the bottom layer; a silt management layer adjacent to the bottom layer; an insulation layer adjacent to the silt management layer; a water retention layer adjacent to the insulation layer, a growth media layer adjacent to the water retention layer; a biodegradable layer including plant seed adjacent to the growth media layer; a top layer including a porous structure such that water and sunlight may pass through the top layer, wherein the top layer and the bottom layer form a perimeter within which the silt management layer, the water retention layer, the growth media layer and the biodegradable layer are contained; and a plurality of thickness controllers spaced intermittently such that the distance between the bottom layer and the top layer is limited by the thickness controllers.

### CROSS-REFERENCE TO RELATED APPLICATIONS

This application incorporates by reference and claims priority to U.S. Provisional Patent Application No. 61/116,872 filed Nov. 21, 2008.

### BACKGROUND OF THE INVENTION

The present subject matter relates generally to a modular green roof system. More specifically, the present invention relates to a light-weight, pre-seeded, fully-contained, multi-layered modular green roof system that supports plant life and allows rainwater to flow through onto building roofs.

Green roofs are designed to minimize the effects of storm water surge (the sudden overburden of the storm sewer infrastructure by a heavy rain event) by temporarily holding and retaining rainwater, which is slowly released onto the roof surface as the water filters through the green roof system. In addition, green roofs minimize the heat island effect found in urban areas where natural terrain has been replaced by concrete and asphalt, which tend to radiate heat rather than absorb it. The plants growing on green roofs help to filter and clean the air, and the entire system can provide habitat for birds and other animals, reduce ambient noise and vibration, and minimize thermal shock, hail and UV degradation for roofing membranes by providing an additional layer of protection and may be visually attractive. Green roofs can also play a significant role in keeping roofs cool in the summer, thus providing the additional benefit of energy conservation. In some situations, green roofs help protect building roofs from fires. When well-executed, green roofs may allow for access to the roof membrane, be relatively lightweight and relatively low cost.

However, until now there have been no light-weight, pre-seeded, fully-contained, multi-layered modular green roof systems that support plant life and allow rainwater to flow through onto building roofs.

Accordingly, a need exists for a modular green roof system as described and claimed herein.

### BRIEF SUMMARY OF THE INVENTION

The modular green roof system disclosed herein provides a light-weight, pre-seeded, fully-contained, multi-layered modular green roof system that supports plant life and allows rainwater to flow through onto building roofs. The green roof system is a modular, light weight and low cost green roof solution especially designed for large expansive roofs such as big box retail, warehouses, factories and distribution facilities, though it is adaptable to many other installations and uses.

In one embodiment, a green roof system module includes: a water retention layer; a growth media layer; and a porous structural top layer and a structural bottom layer enveloping the water retention layer and the growth media layer.

In another embodiment, a green roof system module includes: a growth media layer; a seed layer; and a porous structural top layer and a structural bottom layer enveloping the growth media layer and seed layer.

In yet another embodiment, a green roof system module includes: a growth media layer; a porous structural top layer and a structural bottom layer enveloping the growth media layer; and a plurality of thickness controllers spaced intermittently throughout the system such that the distance between the bottom surface and the top surface is limited by the thickness controllers.

In still another embodiment, a modular green roof system includes: a bottom layer including a porous structure such that water may pass through the bottom layer; a silt management layer adjacent to the bottom layer; an insulation layer adjacent to the silt management layer; a water retention layer adjacent to the insulation layer, a growth media layer adjacent to the water retention layer; a biodegradable layer including plant seed adjacent to the growth media layer; a top layer including a porous structure such that water and sunlight may pass through the top layer, wherein the top layer and the bottom layer form a perimeter within which the silt management layer, the water retention layer, the growth media layer and the biodegradable layer are contained; and a plurality of thickness controllers spaced intermittently such that the distance between the bottom layer and the top layer is limited by the thickness controllers.

The green roof system disclosed herein is a lower cost, lighter weight and is faster to install than the known prior art. In one embodiment in particular, the green roof system is designed to serve as a ballast substitution for the estimated one billion square feet of ballasted roofs installed every year and serve as replacement for the twenty billion square feet installed since the 1970's. Additionally, the green roof system is adapted to prevent growth media from washing out or being blown out of its packaging, helping to prevent the growth media from collecting near roof drains and contributing to dangerous levels of storm water ponding on a roof. This advantage makes the green roof system ideal for high wind locations, keeping the growth media intact and minimizing the potential for growth media and modules to blow off of roofs.

The green roof modules disclosed herein are multi-layered where a simple substitution of materials can change the water retention capacity, insulation rating and variety of plant species that can be grown in the system. As a result, the system can be tailored to very specific environments, meeting the needs of different plant species and the weight requirements for different structures.

As a fully enclosed system, the green roof system disclosed herein uniquely solves the wash-out problem after heavy rainfall events. By controlling the growth media within enclosed modules, the potential for blocking roof drains is greatly minimized, keeping roofs free of ponding water. The enclosed modules also keep plants growing where they belong, not in washed-out media, minimizing the opportunity for root damage outside of the green roof system. The enclosed modules also protect the plant root structure from extreme UV or wind exposure.

Unlike other modular systems requiring two or more technicians, the size and weight of the modules, as well as the structure within which the layers are enclosed enable the system to be installed by a single installer. Fewer technicians mean faster and less expensive installations. It also means there is less weight on a roof during an installation.

Some of the embodiments of the green roof system disclosed herein include pre-seeded modules, which may reduce the product cost, although pre-seeded modules may also require some initial maintenance, specifically watering.

In some embodiments, the green roof system modules, when saturated with rainwater, weigh approximately the same as the design weight of roof ballast. This allows for the substitution of the green roof modules disclosed herein when re-roofing ballasted roofs. Meeting this weight restriction is a significant advantage of the system herein.

As an enclosed system, the growth media in the green roof modules has limited opportunities to become wind-borne or washed out by heavy rainfall. This gives the green roof system an advantage in heavy rainfall events or in high wind locations. Further, the green roof system modules can be tied together for extreme high-wind applications, which may help to keep the product on the roof, where it belongs.

In some embodiments, the module's external structure incorporates a unique quilt design which helps maintain control over the thickness of the product and manage the overall weight of the product.

Various embodiments of the green roof module may incorporate an insulation layer to improve the insulation characteristics of the module.

Embodiments of the green roof module using specific materials may be 100% recyclable/biodegradable and may possibly qualify for a variety of environmental certifications.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a cross-sectional view of a green roof module.

FIG. 2 is a perspective view of the green roof module shown in FIG. 1.

FIG. 3 is a portion of the cross-sectional view of the green roof module shown in FIG. 1, enlarged to more clearly illustrate the various layers.

FIG. 4 is another cross-sectional view of a green roof module.

FIG. 5 is another cross-sectional view of a green roof module.

### DETAILED DESCRIPTION OF THE INVENTION

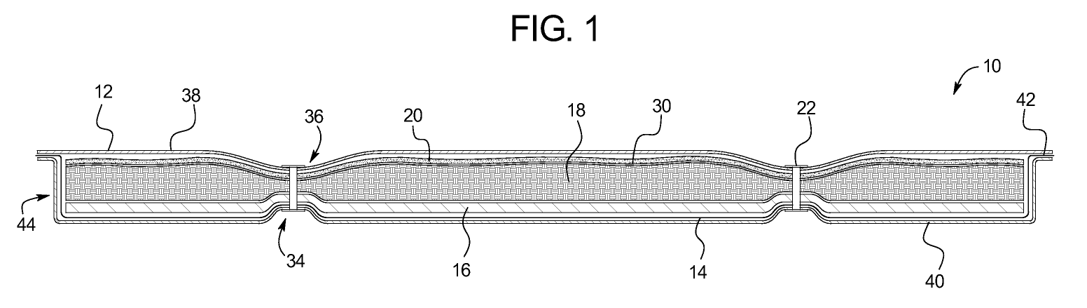

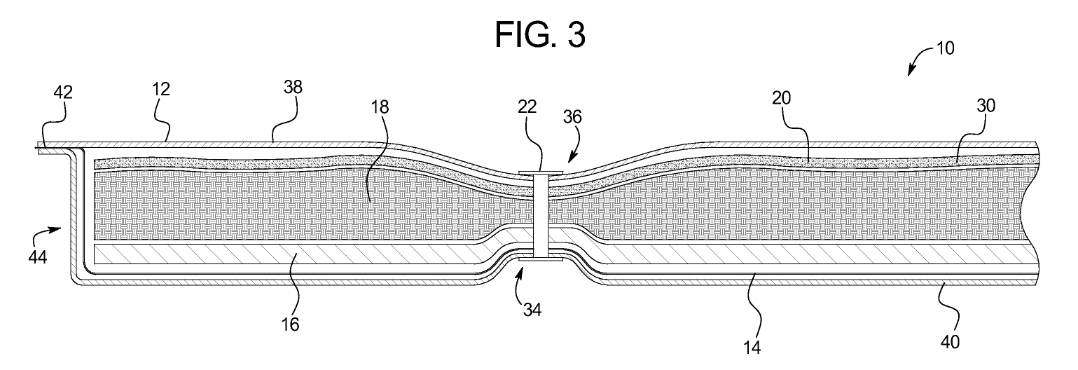

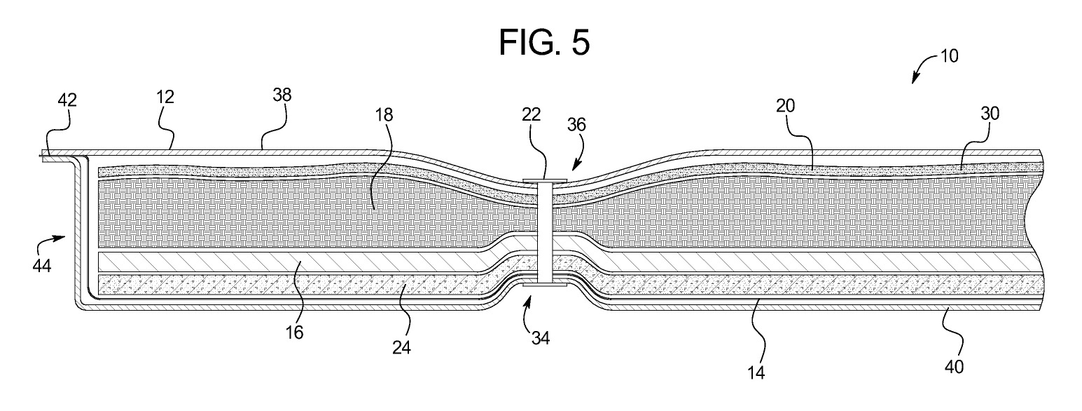

FIG. 1 illustrates an example of a green roof module 10. The embodiment of the green roof module 10 shown in FIG. 1 includes: a porous enclosure 12; a silt management layer 14; a water retention layer 16; a growth media layer 18; a seed layer 20; and a plurality of thickness controllers 22. FIG. 3 illustrates a portion of the same example of a green roof module 10 shown in FIG. 1, wherein the illustration is enlarged to more clearly illustrate the various layers. However, it is contemplated that the green roof module 10 may include a fewer or greater number of elements and layers for particular applications. For example, a green roof module 10 may include a porous enclosure 12, a media layer 18 and a seed layer 20. As another example, a green roof module 10 may include a porous enclosure 12, a water retention layer 16 and a growth media layer 18. Similarly, a green roof module 10 may include a porous enclosure 12, a growth media layer 18 and a plurality of thickness controllers 22. For example, the embodiment shown in FIG. 5 further includes an insulation layer 24. It is further contemplated that the functions of various layers may be merged into a single layer. For example, it is contemplated that the bottom structural layer 40 of the porous enclosure 12 may also function as the silt management layer 14.

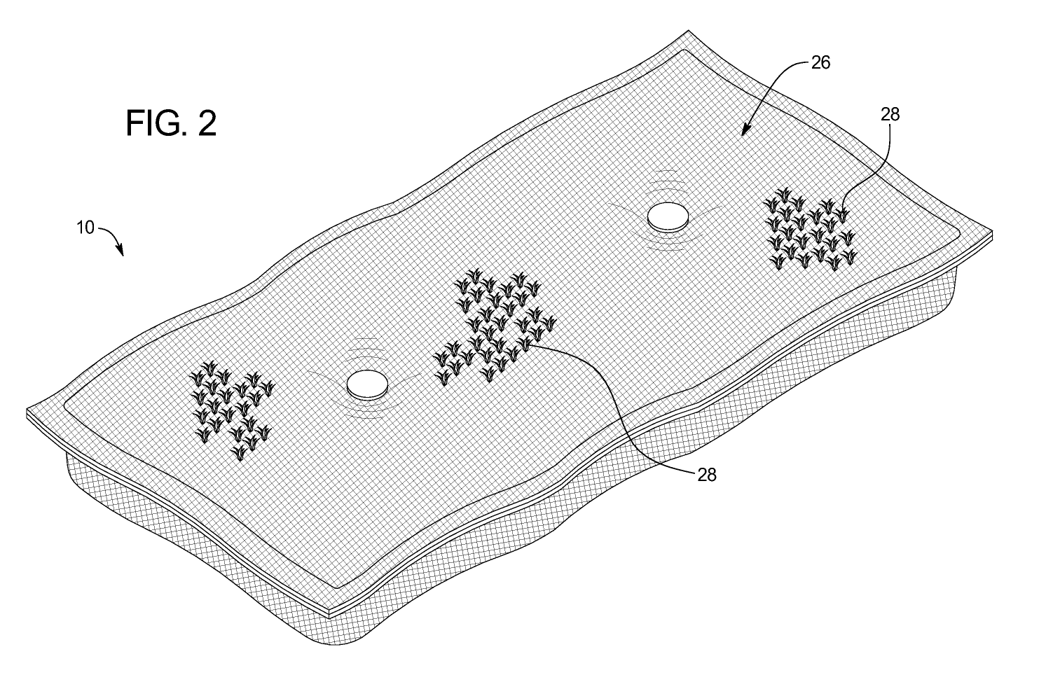

The embodiment of the green roof module 10 shown in FIGS. 1 and 2 is approximately two feet wide, six feet long and approximately one to three inches thick, resulting in a green roof module 10 that is approximately twelve square feet and approximately one to three cubic feet. It is contemplated that the size, shape and weight of the green roof 10 shown will enable the handling and installation of the green roof module 10 by a single installer. For example, the installer may lift the green roof module 10 onto his or her shoulder, carry it across the roof to the installation point and place the green roof module 10 in position. It is further contemplated that other shapes and sizes may be adapted for other installation scenarios. For example, it is contemplated the green roof module 10 may resemble smaller panels, which may be tied together to create larger sections to encourage stability once installed. For example, the green roof module 10 may be one foot by one foot squares that are adhered together during installation.

In the example shown in FIG. 1, the porous enclosure 12 is a fiberglass mesh having a plurality of openings 26 (or pores) arranged in an approximately ¼″ grid. The size, shape and arrangement of the openings 26 may vary based on the requirements of the green roof module 10. For example, smaller openings 26 may be advantageous to prevent materials from inadvertently being released from the green roof module 10, whether during handling, installation, when subjected to wind scour, etc. However, some plant growth may require larger openings 26 to prevent restriction of growth. Larger openings 26 may allow for greater exposure to sunlight. In addition, it is understood that the various materials contained within the green roof module 10 (e.g., the porous enclosure 12, the silt management layer 14, the water retention layer 16, the growth media layer 18, the seed layer 20, the thickness controllers 22, the insulation layer 24, etc.) will have an impact on the opening 26 size requirements. For example, if using a biodegradable seed layer 20 incorporating a seed paste that acts to retain a growth media layer 18 beneath it, the openings 26 may be larger than if a seed layer 20 that does not retain the growth media 18 is used. Additionally, the handling and installation requirements may impact the size of the openings 26. As a result, it is contemplated that the size of the openings 26 may be, for example, as small as approximately one-eight inch square or as large as approximately six inches square. Other sizes, including larger and smaller sizes, may be considered based on the requirements of a given installation.

The strength requirements of the porous enclosure 12 may vary widely; however, the main strength requirement of the porous enclosure 12 is that is must maintain structural integrity to hold the materials within the green roof module 10. In the example shown in FIG. 1, the green roof module 10 weighs approximately four to six pounds per square foot dry, which, at twelve square feet would be 48-72 pounds total.

The porous enclosure 12 may further be recyclable, resistant to UV degradation and be fire resistant and have a smoke development rating to meet any code requirements. For example, in the example shown in FIG. 1, the porous enclosure 12 is fiberglass, highly resistive to UV, self-extinguishes (i.e., does not contribute to fire) and maintains the strength requirements. It is contemplated that thermoplastic polyolefin (TPO) may be another useful material with respect to strength and code requirements and is also 100% recyclable. It may be possible using TPO to manufacture a green roof module 10 that is 100% recyclable/biodegradable. The strength of TPO may further allow for larger openings 26 if the materials can be retained within the green roof module 10 despite the larger openings 26. If the growth media 18 is contained under a structural seed layer 20 (for example, a seed layer 20 incorporating a mesh structure), the openings 26 may, for example, be as large as six inches square. It is contemplated that various other materials may be suitable for use as the porous enclosure 12 or that multiple materials may be used to form the porous enclosure 12 subject to the materials ability to meet the objectives the subject matter disclosed herein. For example, it is contemplated that the top structural layer 38 and the bottom structural layer 40 may be made from different materials and/or may have different opening 26 configurations.

In the example shown in FIG. 1, the silt management layer 14 is a woven HDPE geotextile fabric such as those commonly used for sediment control. Accordingly, the silt management layer 14 is porous, water permeable and adapted to retain the other materials within the green roof module 10. Using materials that have been tested and approved for the EPA standards for stormwater runoff may help the green roof module 10 meet future codes and requirements. It is contemplated that the silt management layer 14 may be formed from any material that is adequately water permeable, but retains the materials within the green roof module 10. Additionally, the function of the silt management layer 14 may be accomplished by the water retention layer 16, such that a single layer accomplishes the requirements of both the silt management layer 14 and the water retention layer 16. Similarly, the function of the silt management layer 14 may be accomplished by the bottom structural layer 40.

The water retention layer 16 shown in FIG. 1 is a layer of felt. In this example, felt was chosen as a natural product with high weight-to-water retention characteristics. The example shown in FIG. 1 is approximately ½″ thick. However, the thickness of the water retention layer 16 may vary from very thin to very thick (e.g., 1/16″ to 1″) based on the material selected and the requirements of the green roof module 10. The water retention layer 16 may be a continuous layer, or may be formed in a shape to fit between the thickness controllers 22.

With the growth media layer 18 held to a minimum thickness to control the saturated weight of the green roof module 10, the water retention layer 16 keeps moisture in the green roof module 10 longer, giving the plants 28 a higher survival rate during a period of drought. It is contemplated that any number of lightweight water absorbing materials may function as the water retention layer 16. Suitable materials may be selected for their weight-to-water absorption qualities and whether they are natural materials allowing for recycling at the end of the life of the green roof module 10. The particular requirements for the water retention layer 16 may be based on the roof slope, the climate zone (i.e., arid vs. temperate) and plant species selected. The thickness and area may be adaptable to meet the plant requirements.

In the example shown in FIG. 1, the growth media layer 18 is an expanded shale media mix. Expanded shale is lightweight and can retain moisture longer than many other media. For example, the growth media layer 18 may be the growing media designed specifically for green roof application sold under the trademark rooflite® by Skyland USA, LLC. The growth media layer 18 may also be a custom mix of expanded shale and mostly inorganic media, which is typical for use as green roof media mix.

In the example shown in FIG. 1, the thickness controllers 22 maintain the growth media layer 18 at approximately two inches thick, which is believed to be a minimum thickness appropriate for long term plant health. However, with the structure of the green roof module 10 providing some shade, the growth media layer 18 may possibly be even thinner. A thicker growth media layer 18 may be useful for promoting plant health, but it also increases the overall weight of the green roof module 10.

The growth media layer 18 may vary in percentage of expanded shale to other media based on climate and plant species. Further, recycled crushed brick and other crushed porous stone (e.g., lava rock) may be a substitute for the expanded shale. In general, any lightweight, porous media that can support plant life may be used in the growth media layer 18

In the embodiment shown in FIG. 1, there is a seed layer 20 above the media layer 18. The seed layer 20 shown in FIG. 1 incorporates a layer of tight pattern burlap 30 with a seed paste applied thereto. The burlap 30 helps retain the growth media layer 18 in place during handling, installation and use and is adaptable such that as the plants 28 grow, the burlap 30 allows the plants 28 to grow unrestricted through the seed layer 20 and the porous enclosure 12, as shown in FIG. 2. The seed layer 20 may help to keep the growth media layer 18 in the product when carried by an installer, create a framework to hold the seeds in place and allow the plants 28, and water to penetrate. Further, using a biodegradable material, such as, for example, the burlap shown in FIG. 1, enables the green roof module 10 to be comprised entirely of recyclable and biodegradable materials.

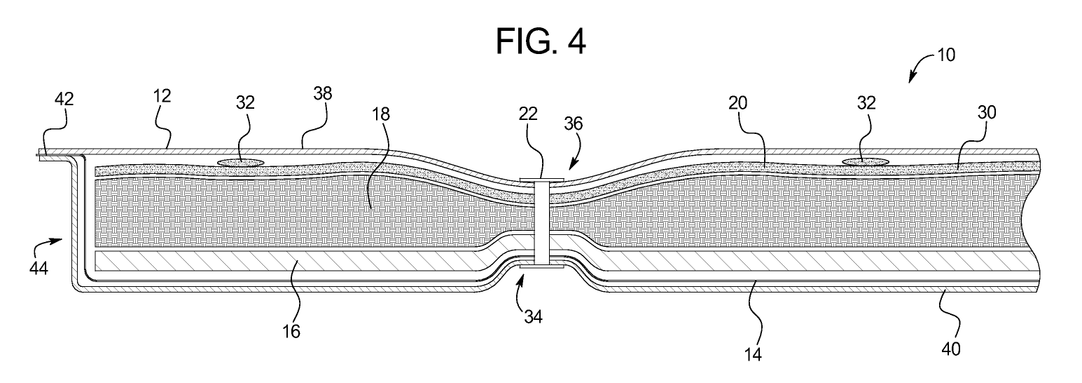

Sedum is a plant 28 frequently specified for the green roof module 10 shown in FIG. 1. There are about 400 species of sedum, which grow in every climate zone. Many varieties of sedum can grow in crevices of rock outcroppings with seemingly no soil and some species have the common name of “stonecrop.” Because simply spreading the seeds is difficult as the seeds are smaller than poppy seeds, the seeds may be applied in a seed paste. The seed paste used in the seed layer 20 shown in FIG. 1 is a mix of cornstarch and water that is heated to a paste, cooled, and then the plant seeds are mixed into the paste to form a consistency of putty. The paste may then be applied to the burlap 30 in seed modules 32 as shown in FIG. 4. Alternatively, the paste may be thinned and continuously sprayed onto the burlap 30, where it may dry as a continuous layer as shown in FIGS. 1, 3 and 5.

The seed density may vary by species. For the species of sedum shown in FIG. 2, the seed density is ideally an order of magnitude of twelve seeds per sq. inch, such that, if one third of the plants 28 germinate, the green roof module 10 would generate four plants 28 per sq. inch.

It is contemplated that in a full roof installation one may use, for example, six species of plants 28 to promote diversity and adaptability to the rooftop micro-climates. Micro-climates can be created by reflections off rooftop equipment, shadows from rooftop equipment or pipes, roof slopes, and adjacencies to vertical surfaces all create different micro-climates. The seed paste/slurry used in the seed layer 20 can help to insure a consistent mix to promote diversity. As will be recognized, any number of species of plants 28 may be used in a given application.

Although the seed layer 20 shown in FIG. 1 utilizes burlap 30 including a seed paste 32 applied thereto, it is contemplated that other materials may be incorporated and that the seeds may be applied within the layer in any manner. As with the other layers described herein, it is further contemplated that the green roof module 10 may omit the seed layer 20.

FIG. 1 illustrates a quilted pattern created in the green roof module 10 by a plurality of thickness controllers 22. The thickness controllers 22 shown in FIG. 1 are plastic pins that snap together from the top and bottom. The use of plastic pins eliminates the threat of rust and helps to prevent roof damage. However, in some cases, use of metal pins may increase the lifespan of the thickness controllers 22, as some plastics may degrade due to exposure to UV.

Thickness controllers 22 may be helpful to manage the overall thickness of the green roof module 10 for weight management. It is contemplated that in one embodiment the product should weigh no more than eight to nine pounds per square foot dry, and no more than about twelve pounds per square foot when saturated.

In the embodiment shown in FIG. 1, the thickness controllers 22 cinch the porous enclosure 12 to a minimum depth of approximately one inch. The cinched porous enclosure 12 forms channels 34 that allow the flow of water underneath the green roof module 10. The cinched porous enclosure 12 also forms low spots 36 which helps promote the rainwater to flow through the green roof module 10, rather than off the top and down the sides of the green roof module 10.

Alternatively, the thickness controllers 22 may be areas within the porous enclosure 12 wherein the top structural layer 38 and bottom structural layer 40 are sewn or otherwise bonded (i.e., chemically or with heat) together to manage the thickness of the green roof module 10. Another alternative would be to scale down the size of the green roof module 10, to, for example, one foot wide by one foot long by two inches thick. The smaller green roof module 10 would control the overall thickness and the smaller green roof modules 10 could be attached together like a quilt. In such an embodiment, no pins or other thickness controllers 22 would be needed to control the thickness of the green roof module 10.

It is further contemplated that some embodiments of the green roof module 10 may incorporate an insulation layer 24 to further improve the insulating and energy saving features of the green roof module 10. For example as shown in FIG. 5, the insulation layer 24 may be located between the water retention layer 16 and the silt management layer 14 and is an insulation layer sufficient to provide an insulation value of R-5. The insulation layer shown in FIG. 5 is formed by combining a plurality of individual insulator pieces to develop a porous layer. However, it is understood that any insulating material capable of meeting the weight, permeability and durability requirements of the green roof module 10 may be used.

The porous enclosure 12 shown in FIGS. 1-5 has a porous top structural layer 38 and porous bottom structural layer 40 that are bound together at the edges of the green roof module 10 to form a sealed perimeter 42. Thus, the top layer 38 and the bottom layer 40 themselves form the sides 44 of the green roof module 10. Alternatively, the sides 44 may be formed from another material or structure.

It is further contemplated that the porous top structural layer 38 and porous bottom structural layer 40 may be made from the same or from dissimilar materials. For example, in some cases it may be preferable to use a porous top structural layer 38 with an opening 26 size, shape and/or density that is different from the porous bottom structural layer 40. Alternatively, in some embodiments the bottom structural layer 40 may be non-porous such that the water filtration through the green roof module 10 has the water exiting through the sides 44 rather than the bottom structural layer 40.

As used herein, the term “layer” may apply to an amount of material that prevents otherwise adjacent layers from being in contact with each other and may also apply to an amount of material insufficient to prevent otherwise adjacent layers from being in contact with each other. In other words, a layer is not required to span all of the square footage of the green roof module 10.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A green roof module comprising:
a water retention layer;
a growth media layer; and
a porous structural top layer and a structural bottom layer enveloping the water retention layer and the media layer.

2. The green roof module of claim 1, further including a seed layer adjacent to the growth media layer.

3. The green roof module of claim 1, further including a plurality of thickness controllers spaced intermittently throughout the module such that the distance between the bottom surface and the top surface is limited by the thickness controllers.

4. The green roof module of claim 1, further including a silt management layer adjacent to the growth media layer.

5. The green roof module of claim 1, wherein the structural bottom layer is porous.

6. The green roof module of claim 1, wherein the water retention layer includes a felt material.

7. The green roof module of claim 1, wherein the growth media layer includes expanded shale.

8. A green roof module comprising:
a growth media layer;
a seed layer; and
a porous structural top layer and a structural bottom layer enveloping the media layer and seed layer.

9. The green roof module of claim 8, further including a silt management layer adjacent to the structural bottom layer.

10. The green roof module of claim 8, further including a plurality of thickness controllers spaced intermittently throughout the module such that the distance between the bottom surface and the top surface is limited by the thickness controllers.

11. The green roof module of claim 8, further including a water retention layer adjacent to the growth media layer.

12. The green roof module of claim 8, wherein the seed layer includes a burlap material.

13. The green roof module of claim 8, wherein the seed layer includes a seed paste formed from a mixture including cornstarch, seeds and water.

14. The green roof module of claim 13, wherein the seed paste is spread approximately uniformly over a material to form the seed layer.

15. A green roof module comprising:
a growth media layer;
a porous structural top layer and a structural bottom layer enveloping the growth media layer; and
a plurality of thickness controllers spaced intermittently throughout the module such that the distance between the bottom surface and the top surface is limited by the thickness controllers.

16. The green roof module of claim 15, further including a silt management layer adjacent to the structural bottom layer.

17. The green roof module of claim 15, further including a seed layer adjacent to the growth media layer.

18. The green roof module of claim 15, further including a water retention layer adjacent to the growth media layer.

19. The green roof module of claim 15, wherein the thickness controllers are pins.

20. The green roof module of claim 19, wherein the pins are plastic.
